(19) United States
(12) Patent Application Publication
(10) Pub. No.: US 2024/0147374 A1
(43) Pub. Date: May 2, 2024

(54) WIRELESS LOCAL AREA NETWORK (WLAN) POWER MANAGEMENT

(71) Applicant: NXP USA, Inc., Austin, TX (US)

(72) Inventors: Liwen Chu, San Ramon, CA (US); Kiseon Ryu, San Diego, CA (US); Hongyuan Zhang, Fremont, CA (US)

(21) Appl. No.: 18/496,555

(22) Filed: Oct. 27, 2023

Related U.S. Application Data
(60) Provisional application No. 63/381,295, filed on Oct. 28, 2022.

(51) Int. Cl. H04W 52/02

(52) U.S. Cl. CPC H04W 52/0235; H04W 52/0206; H04W 84/12

(57) ABSTRACT

One example discloses a method of power management in a WLAN (wireless local area network), the method including: transmitting, by a WLAN device, a first beacon frame and a second beacon frame; and transmitting, by the WLAN device, a power mode announcement frame between transmissions of the first and second beacon frames; wherein the power mode announcement frame indicates whether the WLAN device is in a power save mode.

### REFERENCE TO PROVISIONAL APPLICATION TO CLAIM PRIORITY

A priority date for this present U.S. patent application has been established by prior U.S. Provisional Patent Application, Ser. No. 63/381,295, entitled “AP MLD Power Management With Association, Mode Switch, Power Save Enabling”, filed on Oct. 28, 2022, and commonly assigned to NXP USA, Inc.

The present specification relates to systems, methods, apparatuses, devices, articles of manufacture and instructions for WLAN power management.

### SUMMARY

According to an example embodiment, a method of power management in a WLAN (wireless local area network), the method comprising: transmitting, by a WLAN device, a first beacon frame and a second beacon frame; and transmitting, by the WLAN device, a power mode announcement frame between transmissions of the first and second beacon frames; wherein the power mode announcement frame indicates whether the WLAN device is in a power save mode.

In another example embodiment, further comprising transmitting the power mode announcement frame at least twice as often as the beacon frame.

In another example embodiment, further comprising transmitting the power mode announcement frame at a higher frame rate frequency than as the beacon frame.

In another example embodiment, the first beacon frame includes a target beacon transmission time (TBTT) interval indicating when the second beacon frame will be transmitted.

In another example embodiment, the power mode announcement frame is transmitted before the TBTT interval ends.

In another example embodiment, the power mode announcement frame indicates whether the WLAN device is in an active mode.

In another example embodiment, the power mode announcement frame includes a mode switch time indicating a time when the WLAN device switches between the power save mode to the active mode or when the WLAN device switches between the active mode to the power save mode.

In another example embodiment, the WLAN device and a second WLAN device are part of a same BSS (basic service set).

In another example embodiment, the WLAN device is an access point (AP) and the second WLAN device is a non-AP station (STA).

In another example embodiment, the non-AP STA is an unassociated non-AP STA and is configured to send a probe request frame to the AP in response to receiving the power mode announcement frame.

In another example embodiment, further comprising: receiving, from the non-AP STA, a disable power save mode request; and remaining, by the AP, in an active (non-power save) mode.

In another example embodiment, further comprising: enabling power save mode, by the AP, upon accepting association from a UHR STA.

In another example embodiment, the WLAN device is an access point (AP) multi-link device (MLD), the second WLAN device is a non-AP-MLD, and the AP-MLD is associated with the non-AP MLD.

In another example embodiment, the AP-MLD is configured to transmit the beacon frame on a first link between the AP-MLD and the non-AP-MLD and to transmit the power mode announcement frame on a second link between the AP-MLD and the non-AP-MLD.

In another example embodiment, a first set of links between the AP-MLD and the non-AP-MLD are in the power save mode, and a second set of links between the AP-MLD and the non-AP-MLD are in the active mode.

In another example embodiment, the AP-MLD is configured to announce on a first link with the non-AP-MLD, that a second link with the non-AP-MLD will be transitioned to the power save mode.

In another example embodiment, the announcement includes a BPCC (Beacon Parameters Change Count).

In another example embodiment, the AP-MLD receives an ML Probe Request from the non-AP MLD on a first link with the non-AP-MLD; the AP-MLD transmits an ML Probe Response on a second link with the non-AP-MLD; and the ML Probe Response includes a power save mode switch time.

In another example embodiment, the AP-MLD is configured to disallow the non-AP-MLD usage of one or more of a set of MLD links using a TID to link mapping.

In another example embodiment, the AP-MLD is configured to disassociate from the non-AP-MLD before the AP-MLD enables its power save mode.

In another example embodiment, the AP-MLD is configured to negotiate with the non-AP-MLD STA1 regarding when the AP-MLD's power save mode is either enabled or disabled.

In another example embodiment, the AP-MLD is configured to enable a power save mode upon accepting an association from an EHT STA that support an individual TWT (target wake time).

In another example embodiment, the AP-MLD is configured to enable a power save mode upon accepting an association from an HE STA that supports an individual TWT.

According to an example embodiment, a first WLAN (wireless local area network) device configured as an access point (AP), comprising: a controller configured to, transmit a first beacon frame and a second beacon frame; and transmit a power mode announcement frame between transmissions of the first and second beacon frames; wherein the power mode announcement frame indicates whether the WLAN device is in a power save mode.

The above discussion is not intended to represent every example embodiment or every implementation within the scope of the current or future Claim sets. The Figures and Detailed Description that follow also exemplify various example embodiments.

Various example embodiments may be more completely understood in consideration of the following Detailed Description in connection with the accompanying Drawings.

### BRIEF DESCRIPTION OF THE DRAWINGS

FIG. 1 represents an example wireless local area network (WLAN).

FIG. 2 represents an example protocol for interleaving power mode announcement frames with beacon frames.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

### DETAILED DESCRIPTION

IEEE (Institute of Electrical and Electronics Engineers) 802 defines communications standards for various networked devices (e.g., Local Area Networks (LAN), Metropolitan Area Networks (MAN), etc.). IEEE 802.11 further defines communications standards for Wireless Local Area Networks (WLAN). As such, communications on these networks must, by agreement, follow one or more communications protocols (i.e. be standards compliant) so that various network devices can communicate. These protocols are not static and are modified (e.g., different generations) over time, typically to improve communications robustness and increase throughput.

In embodiments of a wireless communication network described below, a wireless communications device such as an access point (AP) of a wireless local area network (WLAN) transmits data streams to one or more client stations (STAs). The AP and STAs communicate using one or more communication protocols. These protocols may include IEEE protocols such as: 802.11b; 802.11g; 802.11a; 802.11n [i.e. HT (High Throughput) with Single-User Multiple-Input Multiple-Output (SU-MIMO)]; 802.11ac [i.e. VHT (Very High Throughput) with downlink Multi-User MIMO (MU-MIMO)]; 802.11ax [i.e. HE (High Efficiency) operating at both 2.4- and 5-GHz bands, including OFDMA (Orthogonal Frequency Division Multiple Access) and MU-MIMO with uplink scheduling]; and 802.11be [i.e. EHT (Extra High Throughput) operating at 2.4 GHz, 5 GHz, and 6 GHz frequency bands and a much wider 320 MHz bandwidth].

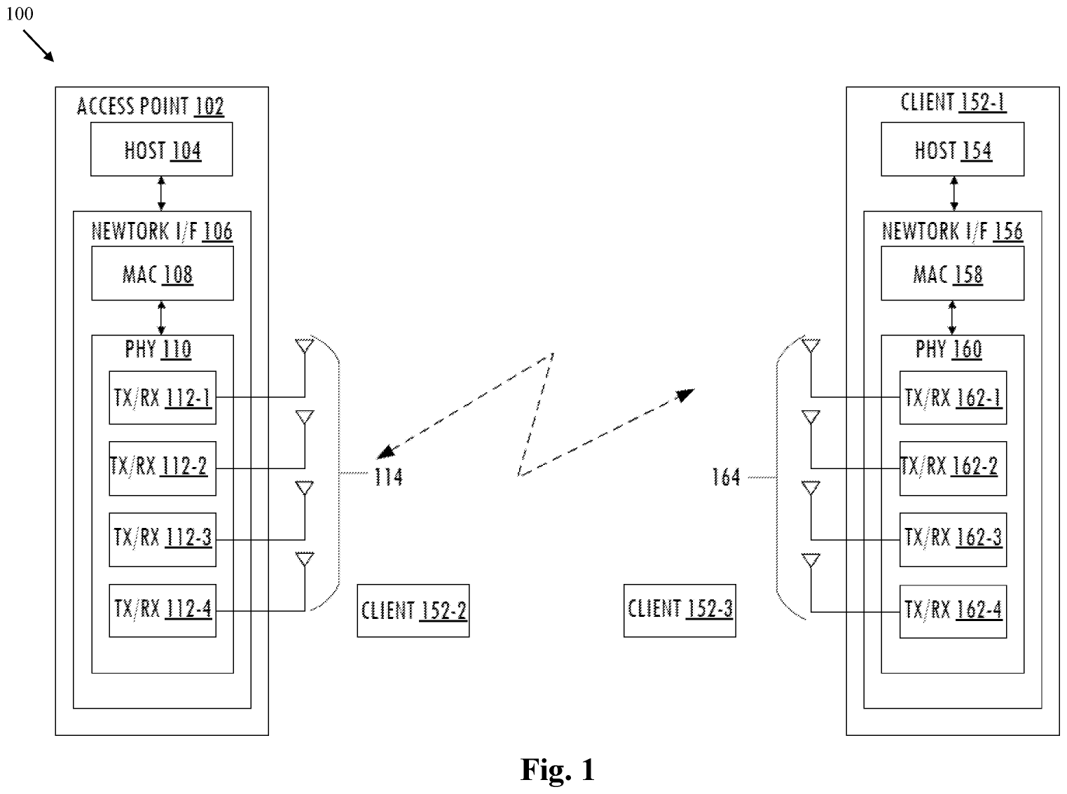

FIG. 1 represents an example 100 wireless communications network (WLAN) formed by a first set of wireless communications devices (i.e. AP STAs and Client-STAs). The WLAN 100 includes access point station (AP STA) 102 and a set of non-AP stations (non-AP/Client STAs) 152-1, 152-2, and 152-3.

The AP 102 includes host processor 104 (e.g., controller) coupled to network interface 106. Host processor 104 includes a processor configured to execute machine readable instructions stored in a memory device (not shown), e.g., random access memory (RAM), read-only memory (ROM), a flash memory, or other storage device.

Network interface 106 includes medium access control (MAC) processor 108 and physical layer (PHY) processor 110. In some example embodiments the MAC processor 108 operates at the data-link layer of the OSI (Open Systems Interconnection) model and the PHY processor 110 operates at the physical layer of the OSI model.

The PHY processor 110 includes a plurality of transceivers 112-1, 112-2, 112-3, and 112-4, each of which is coupled to a corresponding antenna of antennas 114. These antennas 114 can support MIMO functionality. Each of transceivers 112-1, 112-2, 112-3, and 112-4 includes a transmitter signal path and a receiver signal path, e.g., mixed-signal circuits, analog circuits, and digital signal processing circuits for implementing radio frequency and digital baseband functionality. The PHY processor 110 may also include an amplifier (e.g., low noise amplifier or power amplifier), a data converter, and circuits that perform discrete Fourier transform (DFT), inverse discrete Fourier transform (IDFT), modulation, and demodulation, thereby supporting OFDMA modulation.

The client STAs 152-1, 152-2, and 152-3 each include similar circuits (e.g., host processor 154 (e.g., controller), network interface 156, MAC processor 158, PHY processor 160, transceivers 162-1, 162-2, 162-3, and 162-4, and antennas 164) that provide similar functionality to that of AP 102 but are adapted to client-side specifications.

The MAC 108, 158 and PHY 110, 160 processors within the AP 102 and STA 152-1 exchange PDUs (Protocol Data Units) and SDUs (Service Data Units) in the course of managing the wireless communications traffic. The PHY processor is configured to receive MAC layer SDUs, encapsulate the MAC SDUs into a special PDU called a PPDU (physical layer protocol data units) by adding a preamble.

The preamble (i.e. TXVECTOR, transmission vector) specifies the PPDU's transmission format (i.e. which IEEE protocol (e.g., EHT, HE, etc.) has been used to pack the SDU data payload). The PPDU preambles may include various training fields (e.g., predetermined attributes) that are used by the receiving APs or STAs to perform synchronization, gain control, estimate channel characteristics, and signal equalization. The AP 102 and STA 152-1 then exchange the PPDU formatted wireless communications signals 116.

Beacon frames are one of several IEEE 802.11 management frames transmitted on WLAN networks such as the example 100 one just discussed. Beacon frames are periodically transmitted by an access point (AP) to announce the presence of the WLAN network to other non-AP stations (STA) within range of the AP to form a basic service set (BSS).

Beacon frames synchronize members of the BSS and provide network including: a timestamp for synchronizing the BSS's clocks; a beacon interval (e.g. Target Beacon Transmission Time (TBTT)) announcing a time between beacon transmissions; and various other BSS network information such as an SSID, supported bandwidth and frame rates, a traffic indication map (TIM) (e.g. frames waiting for delivery), and other network parameters. The AP also maintains a TSF (Timing synchronization function) that keeps the timers for all stations in the same basic service set (BSS) synchronized.

The BSS is not a static network of WLAN devices. For example, various APs and non-AP STAs may come on-line or within range, and conversely various APs and non-AP STAs may go off-line and go out of range. As a result various WLAN devices are frequently joining (e.g. becoming affiliated with) the BSS over time.

To reduce unnecessary network traffic and/or to conserve power, these various WLAN devices may stop, reduce, or minimize network transmissions. For example, in IEEE 802.11ax defines a protocol where in an existing BSS an AP is permitted to go to sleep only if all of an already existing set of BSS associated STAs support their own individual TWTs (target wake times) and have individual TWT agreements in place with the AP.

In some 802.11ax embodiments, APs affiliated with an AP MLD have their own individual power save, active, and sleep modes similar to non-AP STAs. Such an AP's power save mode can be announced by another affiliated AP's Beacon (e.g. in an RNR element) or announced by itself. An affiliated AP in its power save mode will not transmit any Beacon frames.

In other 802.11ax embodiments, all of the affiliated AP's of an AP MLD can simultaneously be in their power save mode, provided that a service period has been defined following beacon transmissions for either probing or association.

Now discussed are example embodiments that address how APs in their power save or sleep modes may influence an unassociated or roaming STA's association with the AP's BSS or perhaps another BSS. Using the protocols discussed below, an unassociated STA does not need a long time to figure out whether there is AP in a scanned channel even if the AP itself is in doze state of a power save mode.

For example, an unassociated STA coming on-line or roaming should perhaps best associate with a currently sleeping AP, but does not since the unassociated STA is not aware of the sleeping AP since there are no beacon frame transmissions from that sleeping AP. Thus the unassociated STA may then associate with another non-sleeping AP that is less preferred or that is part of another BSS that is less preferred.

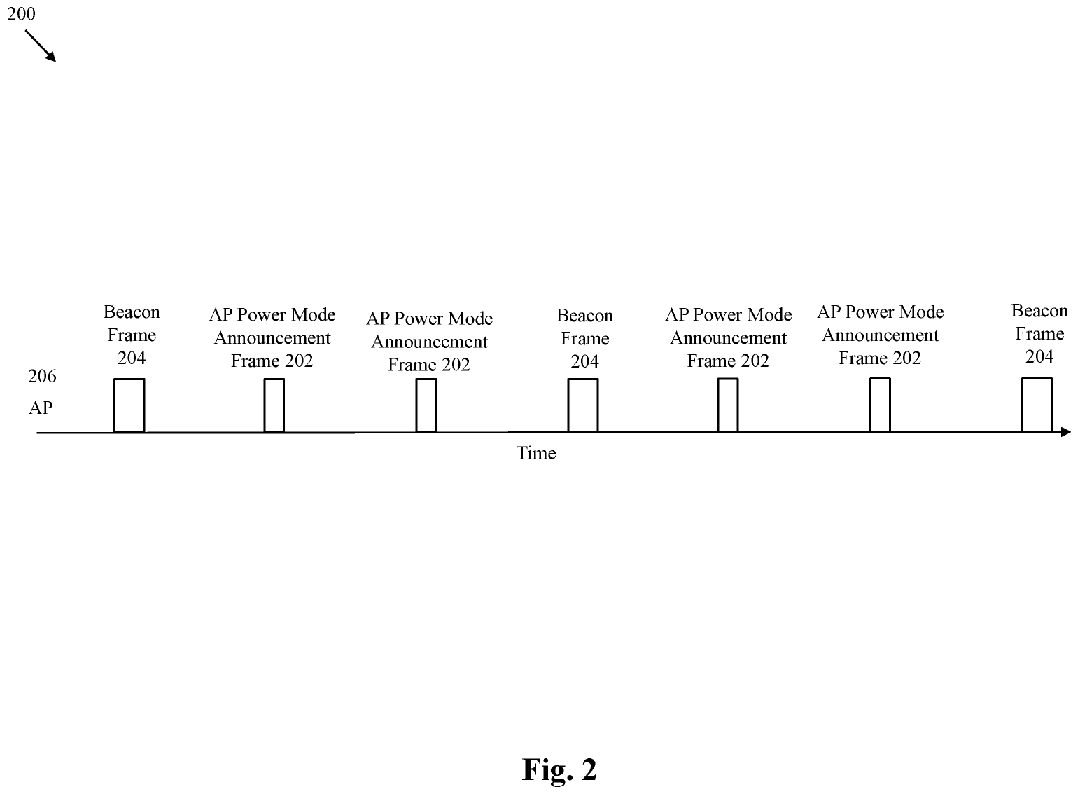

FIG. 2 represents an example protocol 200 for interleaving power mode announcement (e.g. action) frames 202 with beacon frames 204. In this example 200, the AP 206 transmitting the power mode announcement frame 202 with a higher frame rate broadcast frequency than the broadcast frequency of the AP transmission of the beacon frame (i.e. two power mode announcement frames 202 for every beacon frame 204).

For example, during a beacon interval (BI) (e.g. Target Beacon Transmission Time (TBTT)) of an AP in a power save mode, the AP is configured to transmit one or more power mode announcement frame 202 with an announcement interval equal to or greater than the beacon interval (BI).

In various example embodiments, the power mode announcement frame 202 includes a (partial) TSF (Timing synchronization function) time of at least one of: the next TBTT, the AP's SSID, Basic NSS MCS set, and BSS operating BW. An unassociated STA can then be configured to either wait for a next beacon interval frame to be transmitted at a next TBTT, or to send a probe request frame in response to receiving the power mode announcement frame 202.

An AP's power save mode functionality can be enabled and disabled in a variety of ways. In some example embodiments, if just one associated STA (e.g. STA1) in a BSS requests/announces disablement of the AP power save mode, then the AP is required to remain in an active (non-power save) mode. Such a STA1 request can be because STA1 doesn't support the AP power save mode protocol.

In other example embodiments, an AP-MLD associated with a non-AP MLD (STA1) can disallow STA1's usage of one or more of the MLD links using TID to Link mapping. Alternatively, the AP can disassociate from STA1 before the AP enables its power save mode.

In yet other example embodiments, STA1 can be configured to negotiate with the AP before the AP's power save mode is enabled or disabled. In one example embodiment, STA1 STA1 can be configured to negotiate with the AP to request AP to disable power management mode since STA1 have higher traffic load.

In various example embodiments, an AP can enable its power save mode when it only accepts association from UHR STAs (e.g. that the AP MLD that the AP is affiliated with, accepts a multi-link association from UHR non-AP MLDs).

Or in alternative example embodiments, an AP can enable its power save mode when it only accepts association from EHT STA that support (individual) TWT (target wake time) (e.g. that the AP MLD that the AP is affiliated with, accepts the multi-link association from EHT non-AP MLDs, where a UHR STA is an EHT STA and a UHR non-AP MLD is an EHT non-AP MLD).

In other example embodiments, an AP can enable its power save mode when it only accepts association from an HE STA that supports an individual TWT (e.g. that the AP MLD that the AP is affiliated with, accepts the multi-link association from EHT non-AP MLDs, where the EHT STA is an HE STA).

Power mode announcement frames 202 can also be exchanged between AP-MLDs and non-AP-MLDs. Thus within an AP MLD having affiliated links in different frequency bands, if at least one affiliated AP is in an active mode, then the other affiliated APs can be in their power save modes, and an AP associated with the AP MLD in its power save mode will schedule its beacon frame transmissions at its TBTTs. Such MLD power save mode functionality can be implemented in a variety of ways.

For example, wherein the AP-MLD is configured to transmit a beacon frame on a first link between the AP-MLD and the non-AP-MLD, the power mode announcement frame can be transmitted on a second link between the AP-MLD and the non-AP-MLD.

In other example embodiments, a first set of links between the AP-MLD and the non-AP-MLD can be in the power save mode, and a second set of links between the AP-MLD and the non-AP-MLD can be in the active mode.

The AP-MLD can also be configured to announce on a first link with the non-AP-MLD, that a second link with the non-AP-MLD will be transitioned to the power save mode. The announcement can also include a BPCC (Beacon Parameters Change Count).

Also as introduced above, in response to the power mode announcement frame, the non-AP-MLD can be configured to send an ML Probe Request to the AP MLD on a first link, and then the AP-MLD transmits an ML Probe Response on a second link with the non-AP-MLD. In some example embodiments, the ML Probe Response may include the mode switch time (i.e. when the AP-MLD will switch from its active mode to its power save mode on one or more affiliated MLD links).

As mentioned, the AP announces it's current power mode status using the power mode announcement frame broadcast in between the beacon frames. However, the power management functionality can be communicated in a variety of ways.

For example, a MAC header in the power mode announcement frame can be used to announce whether an AP or STA is in power save mode or an active mode.

An AP can announce a time when it will be in power save mode or active mode in its beacon frame; in an RNR element in the beacon frame of another affiliated AP within an AP-MLD, a basic multi-link element in association response frame, or in an ML Probe Response.

A TSF time of a affiliated AP's power management can be based on a TSF time of the affiliated AP that changes its power management mode. The TSF time should be enough for all associated non-AP MLDs to know that the affiliated AP's power management mode is about to change.

When the TSF time for announcing AP's active mode is not defined, i.e. an AP announces its active mode when it is in the active mode after the TBTT, the announcement of an affiliated AP1's active mode in an affiliated AP2's beacon frame, in some example embodiments, needs to be no early than the announcement in the affiliated AP1's beacon frame. The reason for this requirement is that the affiliated AP1 and the affiliated AP2 may have different TBTTs.

In many example embodiments, an AP's power management mode change is considered a critical update. The BPCC (Beacon Parameters Change Count) and the counter for critical update of an AP needs to be increased when the AP's power management mode changes. When one AP announces its power management mode, another AP that is affiliated with the same AP MLD as the AP will increase its counter of critical update.

When one AP (AP1) announces its power management mode, another AP (AP2) that is the transmitted BSSID AP and that is in the same multiple BSSID set as a non-transmitted BSSID AP where the non-transmitted BSSID AP is affiliated with the same AP MLD as the AP1 will increase its counter of critical update. The counter of critical update is related to TIM broadcast frame.

In some example embodiments, when an RNR element is used to carry the AP's power mode switch time, a full critical update of AP1 can be carried in the beacon frame of AP2 affiliated with the same AP MLD as AP1, if for example AP2 doesn't support multiple BSSID. This can be done by setting the Critical Update Flag in Capability Information field to 1, the Beacon Parameters Change Count in RNR element related to AP1 is increased by 1, and all updates Included in in RNR element related to AP1 is set to 1.

In other example embodiments, when RNR carries the AP mode switch time, the full critical update of AP1 can be carried in Beacon of AP2 affiliated with the same AP MLD as AP1 where AP2 has transmitted BSSID. This can be done by setting the Critical Update Flag in Capability Information field is set to 1, the Beacon Parameters Change Count in RNR element related to AP1 is increased by 1, an all Updates Included in in RNR element related to AP1 is set to 1.

In yet other example embodiments, when RNR carries the AP mode switch time, the full critical update of AP1 can be carried in Beacon of AP2 where AP3 and AP2 are in same multiple BSSID set and AP3 and AP1 are affiliated with the same AP MLD. This can be done by setting the Non-transmitted BSSIDs Critical Update Flag in Capability Information field to 1, the Beacon Parameters Change Count in RNR element related to AP1 is increased by 1, and all Updates Included in in RNR element related to AP1 is set to 1.

In some MLD based example embodiments, when RNR doesn't carry the AP mode switch time, the beacon frame of AP2 affiliated with the same AP MLD as AP1 where AP2 doesn't support multiple BSSID has the following information: Critical Update Flag in Capability Information field is set to 1, the Beacon Parameters Change Count in RNR element related to AP1 is increased by 1, and all Updates Included in in RNR element related to AP1 is set to 0.

In other MLD based example embodiments, when RNR doesn't carry the AP mode switch time, Beacon of AP2 affiliated with the same AP MLD as AP1 where AP2 has transmitted BSSID has the following information: Critical Update Flag in Capability Information field is set to 1, the Beacon Parameters Change Count in RNR element related to AP1 is increased by 1, an all Updates Included in in RNR element related to AP1 is set to 0.

In yet other MLD based example embodiments, when RNR doesn't carry the AP mode switch time, the Beacon of AP2 where AP3 and AP2 are in same multiple BSSID set and AP3 and AP1 are affiliated with the same AP MLD has the following information: Non-transmitted BSSIDs Critical Update Flag in Capability Information field is set to 1, the Beacon Parameters Change Count in RNR element related to AP1 is increased by 1, all Updates Included in in RNR element related to AP1 is set to 0.

AP-MLD mode switches can be acquired as follows. A non-AP MLD sends ML Probe Request to AP MLD through AP2 to solicit the AP mode switch, a non-AP MLD sends Probe Request to AP MLD through AP1 or transmitted BSSID AP that is in same multiple BSSID AP set as AP1 for AP mode switch, and a non-AP MLD receives Beacon in AP1's link.

A non-AP MLD can request the AP in one of its setup links in power save mode to active mode through another link or by sending the request to the AP directly. An AP MLD can indicate whether it would like to accept the power management mode change or not. The response frame is cross-link management frame, e.g. the response frame of AP2 can be transmitted by AP2 or another AP affiliated with the same AP MLD as AP2.

Power mode changes can also be effected in some example embodiments by defining a new/modified TWT-SP (service period) field, such as for when both the AP and the STAs in a BSS are in their power save (e.g. dose, sleep, etc.) modes. In such example embodiments, APs and STAs in their doze state can exchange their buffered frames using the TWT SP (e.g. perhaps negotiated).

In some example embodiments, the AP and STA in doze state are awake at the beginning of negotiated TWT SPs. The TWT SP can be ended early when both the AP and the STAs announce that no further frames need to be transmitted in the TWT SP, after which the AP and STAs can switch back to their doze states. An announcement of no more buffered frames can be done through setting a new More Data field to 0 or an EOSP field to 1.

In other example embodiments, the AP and STAs in their doze (e.g. power save) state can exchange their buffered frames at any time when a peer device is in awake state. For example, when an AP has buffered frames for any associated STA, the AP announces such buffering in its beacon frame and stays in its active (i.e. awake) state. A STA with buffered UL (uplink) frames can transmit its buffered frames to the AP without further request of AP switch from doze to awake.

In other examples, when a STA has buffered UL frames and the AP is in doze state, the STA can request AP's switch to awake state through the SP (service period) announced by the AP (e.g. after APs beacon frame) for STA's request of AP state switch (e.g., a frame requesting AP state switch can be a PS Poll frame or a QoS Null frame, which may be with BSR information). The STA then sends a request through a link where the AP of the associated AP MLD in the link is in the active mode (e.g., a frame requesting AP state switch can be a QoS Null frame with an A-Control field including a link ID information). Then after the STA transmits the request by itself of another STA affiliated with the same non-AP MLD, the STA is in awake state.

A STA can switch from its doze (e.g. power save) state to its awake (i.e. active) state by transmitting a PS Poll or another U-APSD trigger frame to an associated AP in a same MLD link as the STA is using. When both the AP and the STAs announce no further buffered frames that need to be transmitted in the TWT SP, the AP and STA can switch back to their doze state.

For example embodiments, where the AP is in its doze state (e.g. power save mode) and one or more STAs are in their active mode (e.g. awake state), the STA (e.g. STA1) can buffer its UL frames if the APs affiliated with the associated AP MLD of the mapped links of the TID of the buffered frames are all in doze state. STA1 then sends a request by itself or by another STA (say STA2) affiliated with the same non-AP MLD as STA1. The request is sent to an AP in active mode (e.g. the AP in STA2's link) or in AP's service period for receiving the awake request from STAs. AP1 that STA1 is associated with, switches to its awake state after receiving the request. STA1 then transmits the buffered frames to AP1 until the buffered frames are all transmitted. AP1 then switches back to doze state after STA1 finishes the transmission of the buffered frames.

Various instructions and/or operational steps discussed in the above Figures can be executed in any order, unless a specific order is explicitly stated. Also, those skilled in the art will recognize that while some example sets of instructions/steps have been discussed, the material in this specification can be combined in a variety of ways to yield other examples as well, and are to be understood within a context provided by this detailed description.

In some example embodiments these instructions/steps are implemented as functional and software instructions. In other embodiments, the instructions can be implemented either using logic gates, application specific chips, firmware, as well as other hardware forms.

When the instructions are embodied as a set of executable instructions in a non-transitory computer-readable or computer-usable media which are effected on a computer or machine programmed with and controlled by said executable instructions. Said instructions are loaded for execution on a processor (such as one or more CPUs). Said processor includes microprocessors, microcontrollers, processor modules or subsystems (including one or more microprocessors or microcontrollers), or other control or computing devices. A processor can refer to a single component or to plural components. Said computer-readable or computer-usable storage medium or media is (are) considered to be part of an article (or article of manufacture). An article or article of manufacture can refer to any manufactured single component or multiple components. The non-transitory machine or computer-usable media or mediums as defined herein excludes signals, but such media or mediums may be capable of receiving and processing information from signals and/or other transitory mediums.

It will be readily understood that the components of the embodiments as generally described herein and illustrated in the appended figures could be arranged and designed in a wide variety of different configurations. Thus, the detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

What is claimed is:

1. A method of power management in a WLAN (wireless local area network), the method comprising:
transmitting, by a WLAN device, a first beacon frame and a second beacon frame; and
transmitting, by the WLAN device, a power mode announcement frame between transmissions of the first and second beacon frames;
wherein the power mode announcement frame indicates whether the WLAN device is in a power save mode.

2. The method of claim 1:
further comprising transmitting the power mode announcement frame at least twice as often as the beacon frame.

3. The method of claim 1:
further comprising transmitting the power mode announcement frame at a higher frame rate frequency than as the beacon frame.

4. The method of claim 1:
wherein the first beacon frame includes a target beacon transmission time (TBTT) interval indicating when the second beacon frame will be transmitted.

5. The method of claim 4:
wherein the power mode announcement frame is transmitted before the TBTT interval ends.

6. The method of claim 1:
wherein the power mode announcement frame indicates whether the WLAN device is in an active mode.

7. The method of claim 1:
wherein the power mode announcement frame includes a mode switch time indicating a time when the WLAN device switches between the power save mode to the active mode or when the WLAN device switches between the active mode to the power save mode.

8. The method of claim 1:
wherein the WLAN device and a second WLAN device are part of a same BSS (basic service set).

9. The method of claim 1:
wherein the WLAN device is an access point (AP) and the second WLAN device is a non-AP station (STA).

10. The method of claim 9:
wherein the non-AP STA is an unassociated non-AP STA and is configured to send a probe request frame to the AP in response to receiving the power mode announcement frame.

11. The method of claim 9, further comprising:
receiving, from the non-AP STA, a disable power save mode request; and
remaining, by the AP, in an active (non-power save) mode.

12. The method of claim 9, further comprising:
enabling power save mode, by the AP, upon accepting association from a UHR STA.

13. The method of claim 1:
wherein the WLAN device is an access point (AP) multi-link device (MLD), the second WLAN device is a non-AP-MLD, and the AP-MLD is associated with the non-AP MLD.

14. The method of claim 13:
wherein the AP-MLD is configured to transmit the beacon frame on a first link between the AP-MLD and the non-AP-MLD and to transmit the power mode announcement frame on a second link between the AP-MLD and the non-AP-MLD.

15. The method of claim 13:
wherein a first set of links between the AP-MLD and the non-AP-MLD are in the power save mode, and a second set of links between the AP-MLD and the non-AP-MLD are in the active mode.

16. The method of claim 13:
wherein the AP-MLD is configured to announce on a first link with the non-AP-MLD, that a second link with the non-AP-MLD will be transitioned to the power save mode.

17. The method of claim 16:
wherein the announcement includes a BPCC (Beacon Parameters Change Count).

18. The method of claim 13:
wherein the AP-MLD receives an ML Probe Request from the non-AP MLD on a first link with the non-AP-MLD;
wherein the AP-MLD transmits an ML Probe Response on a second link with the non-AP-MLD; and
wherein the ML Probe Response includes a power save mode switch time.

19. The method of claim 13:
wherein the AP-MLD is configured to disallow the non-AP-MLD usage of one or more of a set of MLD links using a TID to link mapping.

20. The method of claim 13:
wherein the AP-MLD is configured to disassociate from the non-AP-MLD before the AP-MLD enables its power save mode.

21. The method of claim 13:
wherein the AP-MLD is configured to negotiate with the non-AP-MLD STA1 regarding when the AP-MLD's power save mode is either enabled or disabled.

22. The method of claim 13:
wherein the AP-MLD is configured to enable a power save mode upon accepting an association from an EHT STA that support an individual TWT (target wake time).

23. The method of claim 13:
wherein the AP-MLD is configured to enable a power save mode upon accepting an association from an HE STA that supports an individual TWT.

24. A first WLAN (wireless local area network) device configured as an access point (AP), comprising:
a controller configured to,
transmit a first beacon frame and a second beacon frame; and
transmit a power mode announcement frame between transmissions of the first and second beacon frames;
wherein the power mode announcement frame indicates whether the WLAN device is in a power save mode.
